(19) United States
(12) Patent Application Publication
(10) Pub. No.: US 2021/0061411 A1
(43) Pub. Date: Mar. 4, 2021

(54) Wide range linear to exponential CVT technology, energy saving geometries, short stroke independent pedaling, and reduced friction ball bearings, as embodied in an high performance bicycle

(71) Applicant: James I. Mystery, Cebu City (PH)

(72) Inventor: James I. Mystery, Cebu City (PH)

(21) Appl. No.: 16/602,221

(22) Filed: Aug. 30, 2019

(51) Int. Cl. B62M 6/75; B62M 11/12; B62M 23/00; F16H 15/28

(52) U.S. Cl. CPC B62M 6/75; F16H 15/28; B62M 23/00; B62M 11/12

(57) ABSTRACT

The herein invention presents new technologies for superior performance in bicycles, other human powered vehicles, and other mechanical systems; based on Wide Range Linear to Exponential CVT technology, Energy Saving Geometries, Short Stroke Independent Pedaling, and Reduced Friction Ball Bearings. Said new technologies are superior to prior art technologies in that they enable greater efficiency in the application of power and markedly reduce energy consumption, resulting in higher top speeds as well as much greater hill climbing power.

### CROSS REFERENCE TO RELATED APPLICATIONS

Not Applicable

### STATEMENT REGARDING FEDERALLY SPONSORED RESEARCH OR DEVELOPMENT

Not Applicable

### TECHNICAL FIELD OF INVENTION

This invention relates primarily to bicycles and other human powered vehicles, as well as to a wide variety of rotating mechanical systems in which linear-to-exponential continuously variable transmissions may be applicable. Said invention includes a plurality of high performance technologies, notably energy saving and power gain technologies along with reduced friction ball bearings.

### BACKGROUND OF THE INVENTION

To the present time, the technology and/or design of prior art bicycles and other human powered vehicles that transport people, goods, and services have serious deficiencies limiting the performance of said vehicles and their operators, as described in the following:

The greatest deficiency is the inefficient usage of power. Not only for standard bicycles, but also for variations and adaptations of bicycles such as, for example, three wheeled bicycles carrying passengers and cargo in third world countries. Such vehicles are often unable to ascend hills or steeply inclined bridges unless passengers and/or cargo are first unloaded.

Another deficiency is the failure to consider the ergonomics (kinematics) of hip, knee, and ankle bending during pedal rotation, such that pedal and drive train geometries are flawed insofar as conservation of cyclist's energy are concerned.

Another deficiency is the inadequate gear ratio range, i.e., usually around just over four to one in typical 21 speed bicycles.

Another deficiency, given that pedaling is cadence limited, is that in the highest gear available, cyclist may pedal as fast as possible but is still unable to reach higher speeds in cases of a favoring down slope and tailwind.

Another deficiency is the wasted energy associated with 360° rotary pedaling due to the left and right pedal cranks being joined as one unit, rather than being separated so as to operate independently, such that cyclist must work harder, being obliged to pedal completely through the four quadrants of a circle despite changing load conditions. The upper quadrant of the circle closest to the front of the bicycle requires primarily rotational force rather than downward force, and the mass of the cyclist is initially of no avail in applying force to the pedal. Worse, the two rear facing quadrants accomplish no work and impose unnecessary inertial loads on cyclist's legs. The term “inertial loads” refers to the resistance of vector changes in the angular momentum of cyclist's leg mass.

Another deficiency is the use of gears and gearshift levers to manage power and speed tradeoffs. These are at times subject to a “hit-or-miss” result when it comes to a cyclist selecting the desired gear. This results in fumbling, lost time and forward momentum as cyclist endeavors to correct the gear settings.

Another deficiency is that typical bicycle drive train mechanisms do not provide for near infinite application of force at beginning of pedal stroke, such that the not infrequent demands of greater force cannot be met.

Typical ball bearings use cages (also referred to as retainers or isolators) to keep bearing balls separated so that they don't create friction by rubbing against each other. Cages, while eliminating most of the friction, nonetheless introduce significant scuffing or rubbing friction, resulting in appreciable energy losses not only in bicycles but also in most other mechanical systems in which one or more components rotate around a shaft. Considering how many ball bearings are in use throughout the entire world-13 motor vehicles, hair dryers, computer hard drives, alternators and generators, electric fans, washing machines and dryers, printing presses, aircraft engines, turbine engines on ocean going ships, to name a few—the wasted energy accumulates over time and surely has a substantial impact on global economy as well as stealing energy from cyclists.

### BRIEF SUMMARY OF THE INVENTION

The herein invention is purposed to provide solutions to all of the deficiencies cited in the foregoing BACKGROUND OF THE INVENTION, as follows:

All of the above deficiencies are solved by 1) a linear-to-exponential CVT (continuously variable transmission) technology and 2) cageless ball bearings. With typical prior art bicycles the pedaling is purely linear, such that equal increments of pedaling produce equal increments of forward velocity. In contrast, within the herein system, equal increments of pedaling produce exponential increments in the forward velocity. It can be seen by reviewing the mechanisms presented in the drawings that the pedaling output is exponential, beginning at zero. Since any exponential series beginning with zero is inherently infinite, pedal rotation begins with theoretically infinite power, subject to tolerances and elasticity of materials, albeit power swiftly decreases with the onset of pedal rotation.

Described in detail later, above said technology consists of an arc shaped cam (herein after designated “cam”) removably and eccentrically attached to and rotating with the pedal crank and hub. As cam rotates with the pedal, it winds/pulls increasingly more cable off a gear train connected gear pulley. The rate at which cable winds is exponential, substantially following the cosine function.

Shifting of gears is completely eliminated, as the relative power/speed ratios are a function of depth of stroke, rather than discreet and finite gear settings. By design, the pedal stroke is limited to 45 degrees, which has a plurality of advantages described later.

At this point an important concept is introduced: The Force/Load Balance Point (also expressed as Force/Load Equilibrium). Since, given a much greater Power/Speed Ratio (hereinafter, PSR) at the beginning of pedal descent, it is possible for cyclist to rotate the pedal to some degree, however slightly, until with increasing load, the cyclist reaches a Force/Load Balance Point (hereinafter, FLBP) and motion comes to a standstill. Once at FLBP or at bottom of stroke (hereinafter, BOS), cyclist raises the pedal to begin the next stroke at a more favorable power advantage. Restated, cyclist is not required to force the pedal all the way down to BOS but simply halts the stroke and resorts to the other leg raised some distance above FLBP to continue pedaling. As pedaling continues, the bicycle accumulates forward momentum, and the work done to reach a certain speed (omitting frictional losses) does not need to be repeated. As speed increases, FLBP occurs lower and lower in the stroke. Simply put, “the faster you go, the faster you go.”

Although not claimed in the herein patent application, total power efficiency is further increased by the simple use of an extended handlebar which places cyclist's hands more vertically and directly over the pedal, as seen in FIG. 17, 54. Shorter handlebars result in power being applied as a vector force related to the cosine function. An extended handlebar allows cyclist to pull more strongly upward against the handlebar thereby adding arm strength to leg strength, thus adding to other below described power gains of the herein system.

The deficiency relating to friction due to scuffing or rubbing between bearing balls and their cages (also referred to as retainers or isolators) is solved by substituting balls for cages. Whereas, this is normally impossible due to the enormous friction between counter-rotating balls in direct contact with each other, in the herein invention, by adding two additional arrays of bearing balls, each array rolling upon another, with the middle array replacing the cage, the scuffing/rubbing friction is completely eliminated. Thereuponl, the only remaining friction is rolling friction, which is so slight as to be negligible. Generally, the coefficient of typical ball bearings using cages is greater by a factor of about 35 or more than the coefficient of friction of cageless ball bearings.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE SEVERAL VIEWS OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Before any patent drawings were made, the entire bicycle was first modeled completely in three dimensions in AutoCAD 2014 set to an accuracy of eight decimal points. Orbiting the objects three dimensionally so as to view them from all angles prevented the collision of objects and missing parts not otherwise suspected to exist if working only in two dimensions. The completed AutoCAD drawings were converted to two dimensions using the AutoCAD FLATSHOT command, imported as .dwg files into CorelDRAW, with which suitable line weights could be applied to the main objects and shadings, then exported from CorelDraw as .png files, and then inserted as pictures into MS Word, with which this Patent Application was created.

FIG. 1 is an illustration of the preferred embodiment of the entire bicycle as herein described, showing pedals and rotationally mounted cams, which along with a cable, are the essence of the herein linear to exponential technology.

FIG. 2 is an isometric view of the components of the pedal hub, crank, and pedal cam.

FIG. 3 is a bottom view of the components in FIG. 2, together with a partial bicycle frame.

FIG. 4 is a top view of the essential components of the complete drive train.

FIG. 5 is a front view of the components presented in FIG. 4.

FIG. 6 presents the cable connection between gear pulley and cam, including cable fastening screws.

FIG. 7 indicates the tangent points for pedal cam and gear pulley, so as to establish the required angular relationships between pedal cam and gear pulley.

FIG. 8 illustrates the cable path and length pulled in a full 45 degree pedal rotation.

FIG. 9 illustrates cable paths and lengths pulled, as in FIG. 7, in 2.5° increments of pedal rotation.

FIG. 10 is a list of the net inches of cable pulled, derived from the values in FIG. 9.

FIG. 11 presents an X/Y graph of the power/speed curve, derived from the list in FIG. 10, along with, for comparison, a purely circular curve.

FIG. 12 illustrates pedal (foot) travel and stroke depth existing in typical 360° pedaling given a 7 inch pedal crank.

FIG. 13, by way of comparison to FIG. 12, illustrates pedal (foot) travel and stroke depth based on 45° reciprocal pedaling, given a 5 inch pedal crank.

FIG. 14 illustrates pedaling efficiency as found in conventional 360° pedaling.

FIG. 15, by way of comparison to FIG. 14, illustrates pedaling efficiency as found in the herein system which employs 45° reciprocal pedaling using a 5″ pedal crank.

FIG. 16 presents hip, knee, and ankle joint angles associated with a 90° pedal rotation using a 7″ pedal crank.

FIG. 17 presents hip, knee, and ankle joint angles associated with a 45° pedal rotation using a 5″ pedal crank.

FIG. 18 presents the locations in the herein bicycle in which the herein described reduced friction ball bearings are employed.

FIG. 19 indicates the angular relationships between inner, middle, and outer arrays.

FIG. 20 compares the lengths of radii of the inner, middle, and outer arrays, as measured from bearing shaft center.

FIG. 21 indicates the axial separation distances of inner, middle, and outer arrays.

FIG. 22 depicts the direct ball-to-ball contact between inner and middle arrays.

FIG. 23 presents orthographic exploded and non-exploded views of the reduced friction ball bearing components.

FIG. 24 presents an isometric exploded view of the reduced friction ball bearing components, previously presented in FIG. 23.

### DETAILED DESCRIPTION OF THE INVENTION

It is to be understood that the present invention may be embodied in various forms, especially as regards other types of human powered vehicles and other mechanical devices in addition to bicycles. Therefore, specific details disclosed herein are not to be interpreted as limiting, but rather as a basis for the claims and as a representative basis for teaching one skilled in the art to employ the present invention in virtually any appropriately detailed system, structure or manner.

In accordance with a preferred embodiment of the invention in a high performance bicycle, there is disclosed the following new technology:

A linear to exponential continuously variable transmission technology, which, by virtue of its geometry, enables short stroke 45° independent pedaling which increases speed and power all the while saving cyclist's energy. Said technology provides an infinitely variable power/speed ratio (hereinafter, P/S Ratio, or PSR). Said technology requires no gear shifting, as the ‘gear’ you are in is a function of depth of stroke rather than a function of gears and gear shifting.

Short Stroke Independent Pedaling. Independent Pedaling as used herein means that the rotation of one pedal does has no effect on the rotation of the other pedal. The system therefore may employ partial as well as full strokes. In rotary pedals and solidly linked reciprocal pedals, partial strokes are not possible because the cyclist is obliged to continue pedal rotation despite heavy load conditions. If the load is greater than the force available, pedal rotation ends prematurely, relieved only by changing gears or, perhaps, by dismounting the bicycle and walking it up a grade.

At Top of Stroke (hereinafter, TOS) the crank and pedal are oriented horizontally, i.e., facing the front of the bicycle, such that the cosine series of values for pedal rotation begins at 0°.

Energy (power) efficiency expressed as a percentage is simply the cosine value multiplied by 100. Maximum force and zero speed is found at Cos 0°, equivalent to maximum power, thereafter declining towards zero with the onset of pedal rotation. A point is reached where applied force exactly equals load force, and this point shall be referred to as the Force/Load Balance Point (hereinafter, FLBP).

In the following, the values of calculations are based on and/or by

a) A 7″ pedal crank length in prior art bicycles,
b) A 5″ pedal crank length as used in the herein system,
c) The concept that energy saved is energy earned, a relative term not to be construed as making cyclist more powerful, and
d) Since cyclist ergonomics in the act of pedaling is interrelated with the mechanical system of the bicycle, there are opposing forces of leverage between leg of cyclist and drive train loads occurring with pedal rotation, which are determined by the formula

PGₙ=F+(sin H+sin K+sin A)*100

where;
PGₙ=Net power gain expressed as a percentage,
F=The force required to rotate pedal full stroke,
H=The sine of the angle to which hip joint flexed to reach a full stroke pedal rotation,
K=The sine of the angle to which knee joint flexed to reach a full stroke pedal rotation,
A=The sine of the angle to which ankle joint flexed to reach a full stroke pedal rotation,
e) Cyclist's leg leverage varies between hip, knee, and ankle joints, and at each joint, is a product of force expended by a joint times its associated sine value, inasmuch the two terms are interdependent. Restated simply, leg leverage equals force applied times the sine of a hip, knee, or ankle joint.
f) The average of cosines (energy efficiency), taken in increments of 5° from 0° to 45° (0.89512574) is 1.42298827 times greater than the average of cosines (energy efficiency) from 0° to 90° (0.62904646).

Cyclist ergonomics are often overlooked by engineers who look only at the machine (bicycle) and not at the combination of cyclist and machine. Assume, for example, a force of 90 newtons (hereinafter, N) was expended in reaching a pedal rotation of 45°. It follows, given hip, knee, and ankle joints, that each joint separately expended a force of 90/3=30 N. The force expended in each joint is directly related to the angle of joint rotation. Just what is the relationship? The sine value logically and accurately reflects the energy expenditure of a joint, such that the less the joint bends, the less the energy expenditure. For each joint, the sine value should be multiplied by the force of 30 N.

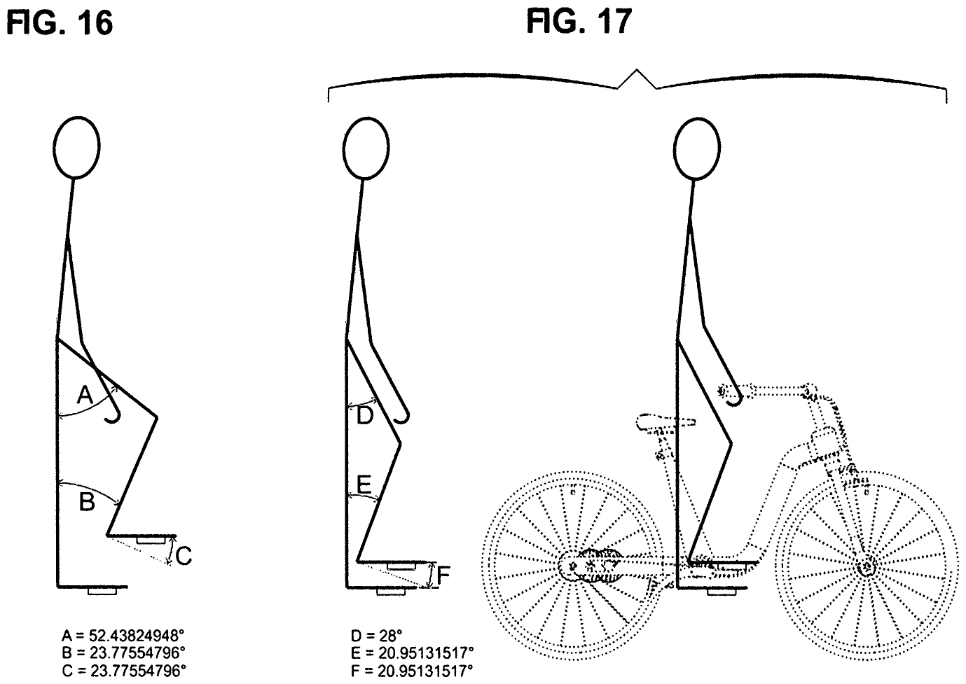

It should be noted that the apparent angles between upper and lower legs, as measured from the knee joint, seen in FIGS. 15 and 16, are not to be used in the formula given above. Rather, the correct angles are those found when upper and lower legs have rotated to vertical and foot rotated to horizontal upon reaching BOS. Thus, following the above formula and working with the angles presented in FIG. 16, the sine of the hip joint flexing 28° is 0.46947156, which summed with the sines of knee and ankle joints, each having the value of 0.35757455, equals 1.18462066, this value indicative of the combined energy efficiency of hip, knee, and ankle joints. Dividing 90 N by 1.18462066 equals 75.97368784 and multiplied by 100 equals 7,597%.

It was previously determined (above) that pedaling through only 45° instead of through 90° produces a net power gain of 1.42298827. Multiplying the two values of net power gained, 1.42298827*7,597%=10,810% total net power gained.

Having reached this point, the energy savings of the herein system should be compared to the energy savings of pedaling 90° in a prior art bicycle. Assume it is the same cyclist; hence, leg lengths are the same. Working with above formula, but increasing pedal rotation from 45° to 90°, and using angles given in FIG. 15, the net power gain is 5,628%. It is seen that the herein system is 10,810%/5,628%=1.92 times more power efficient than nearly all prior art bicycles. Restated, by limiting pedal rotation to 45°, the energy savings is nearly doubled.

As noted previously, net power gain is not to be construed as making cyclist more powerful. It is a relative figure and seen in the correct perspective, is the outcome of one leverage competing against another leverage; that is, the cyclist leg leverage vs the mechanical disadvantage as a cosine value. Let us assume that having reached a pedal rotation of 45°, there is a mechanical disadvantage of cos 45°, 0.70710678, which is equivalent to rotational leverage. As an analogy, we can imagine a lever and pendulum, the pendulum under the lever being set at a distance of 0.70710678 times the length of said lever from the end of said lever, and a force applied to the long end. Opposing the force output of said lever is the force output of a much longer lever (cyclist's legs) with pendulum very near the load end. Obviously, the longer lever has the advantage of the very considerable leverage of the legs, given that the sine values of the angles flexed are much smaller than the sine of 45°. The greater leverage of the legs also operates in prior art bicycles with 360° rotary pedaling; however, the disparity of competing leverages of mechanical advantage vs leg lengths are not as great. Thus, it is concluded that greater energy efficiency is to be had in the herein system, compared to prior art bicycles. Since energy saved is energy earned, this translates into a higher net power gain.

Any doubts as to whether the foregoing assumptions are correct are quickly set aside once a hypothetical huge increase in leg length reduces the sine angle from 28° to 0.028°, the sine of which is 4.88692171⁻⁴. Now, multiplying that by 30 N=0.01466076. Next, multiply by 3 so as to factor in all three joints=0.04398229. Finally, dividing 90 N by 0.04398229 produces a net power gain of 2046.27792120=204,627.79%! This is the proof that leg length is a significant variable in operating a bicycle. Variations in leg length, manner of pedaling, will bring variations in sine values, since longer legs flex less than short legs, hence, taller, long-legged cyclists joint flexure will be reflected in small sine values.

To drive home the point that shorter strokes save energy, a ‘real world’ experiment is in order. Stand on one leg and lower the body 14 inches. Rise and repeat. Continue. After a short while, fatigue sets in. Next, repeat the experiment but lower and raise the body only 3.5 inches. Now at 3.5 inches up and down effort, the bending (flexing) of the hip, knee, and ankle joints is greatly reduced. In this case, the exercise may continue considerably longer before fatigue sets in.

Turning now to the drawings, the aforesaid linear to exponential CVT in the preferred embodiment of a high performance bicycle comprises:

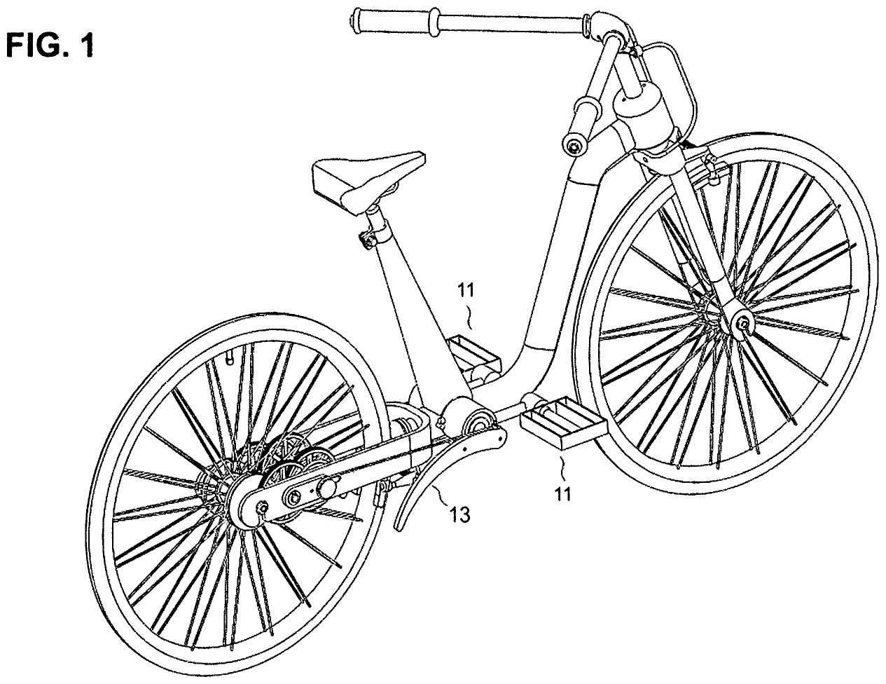

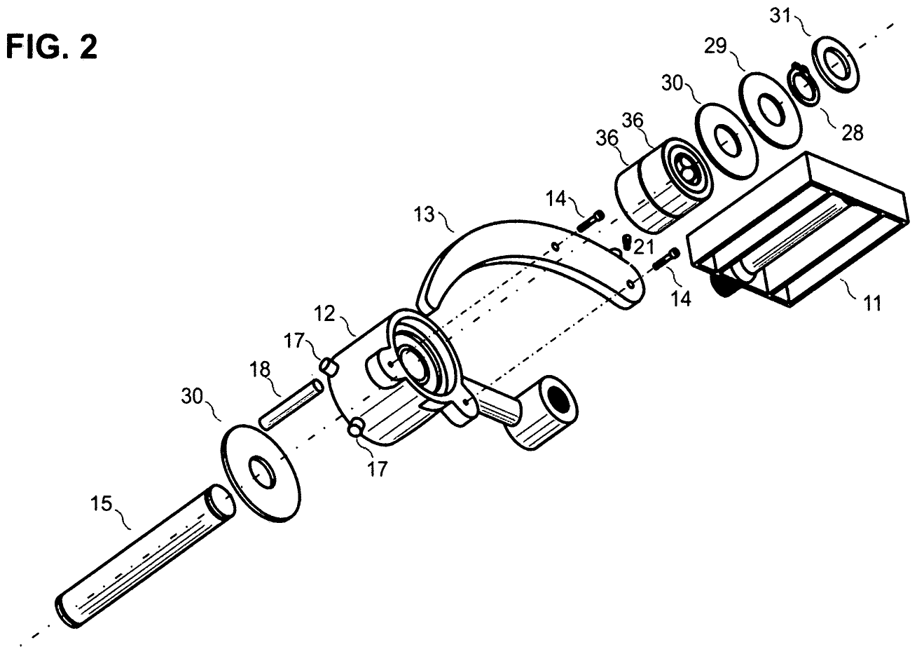

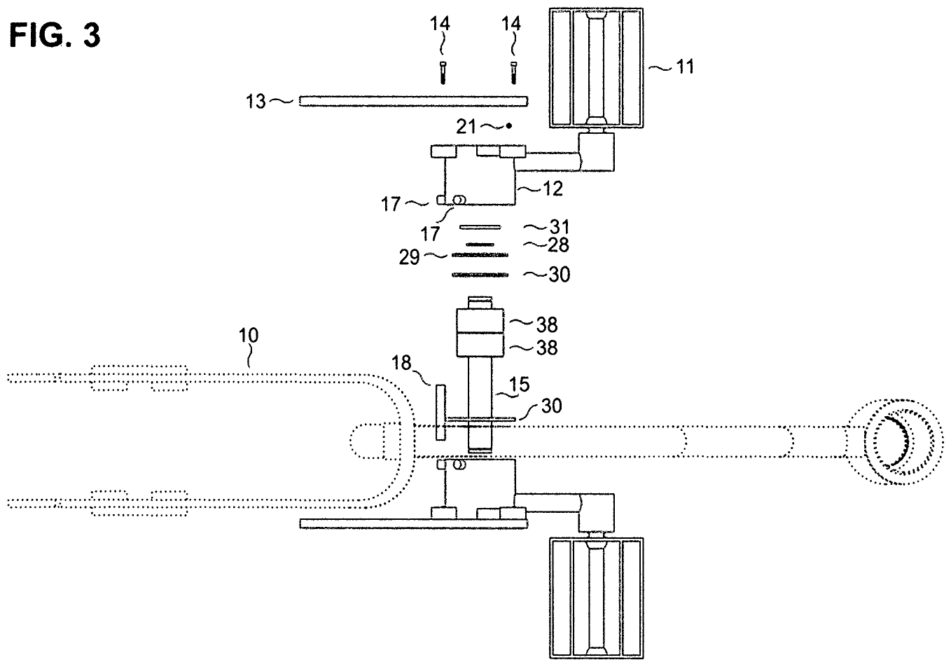

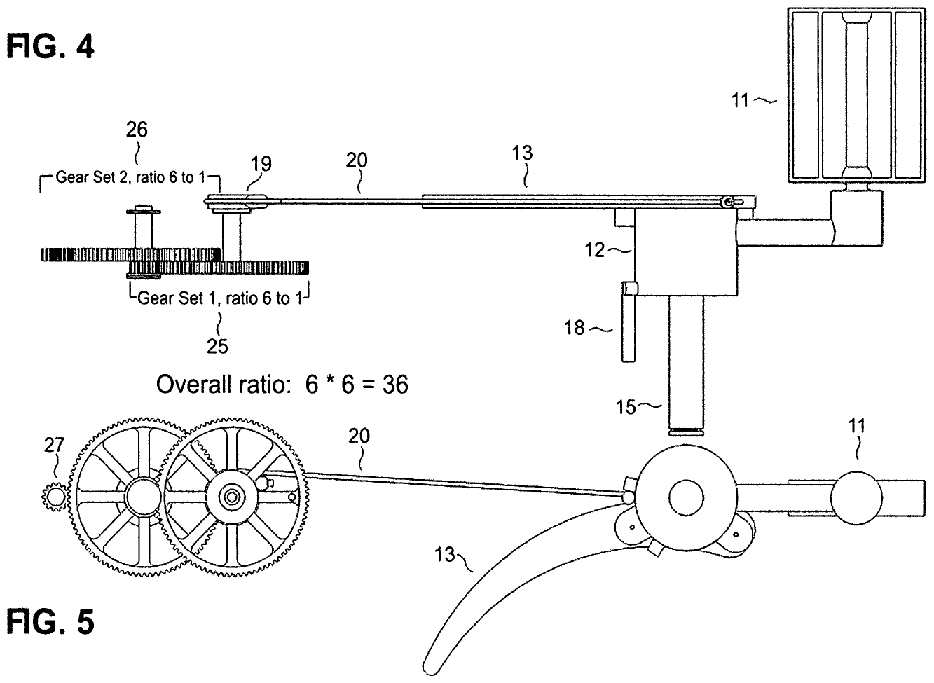

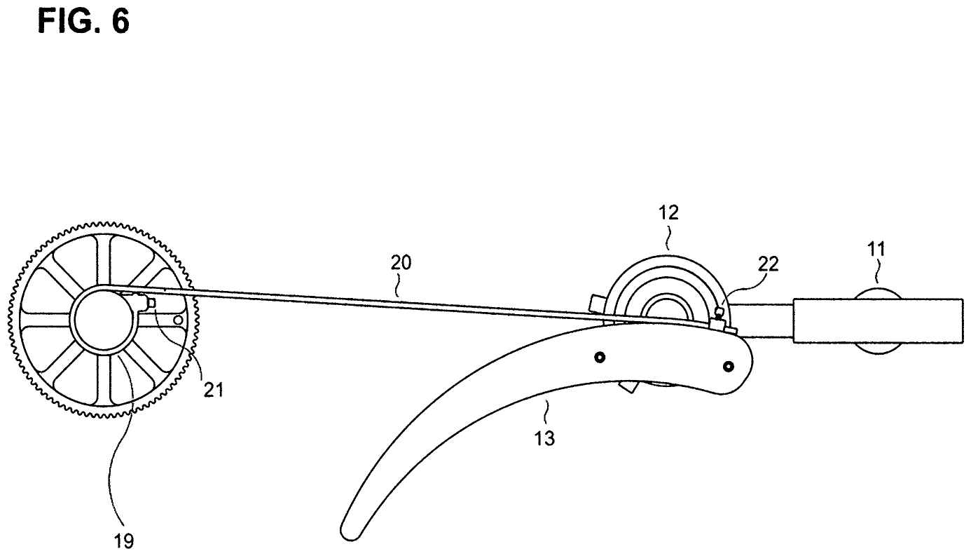

a) A bicycle, similar in most respects to other conventional prior art bicycles, except for the drive train.
b) FIG. 1 shows pedals and pedal cranks 11, both forward facing so as to accommodate independent pedaling, and concentrically disposed about a crank shaft affixed to bicycle frame.
c) FIG. 2 is an exploded view of the components which comprise pedal, pedal hub, and cam, including pedal crankshaft 15, flat ceramic washer 30, (to fit between frame and pedal hub), frame mounted stop bar 18, pedal hub 12, hub mounted stop pins 17, cam 13, cam mounting bolts 14, tandem reduced friction ball bearings 36, flat ceramic washer 30, flat metal washer 29, snap ring 28 used to secure pedal hub to the crankshaft 15, hub dirt seal 31, and pedal 11. For another view of above components, see also FIG. 3. Hub mounted stop pins 17 are also shown in FIG. 2.
d) FIG. 6 shows the cam 13 with mounting bolts FIG. 2, 14 which is eccentrically disposed such that the upper quadrant of the cam is below the center of rotation of the pedal by a vertical distance equal to half the diameter of a cable or other power transmitting medium (hereinafter, “cable”). As used in the herein system, cable diameter is 0.125″.
e) FIG. 6 also shows the cable interconnecting cam 13 and gear pulley 19, one end of the cable affixed to cam with attaching screw 22, the opposite end of cable affixed to gear pulley 19 with attaching screw 21 and partially wound about it. Pedal and cam are also seen in FIGS. 2-5.
f) FIGS. 4 and 5 shows gear pulley 19 rotationally connected by a shaft to a gear train 25, 26.
g) Gear train consists of two sets of gears in tandem, each set having a ratio of 6 to 1, providing an overall ratio of 36 to 1, the last gear in the gear train FIG. 5, 27, disposed as the rear axle gear, which, through intervening components such as a free wheel ratchet device and rear hub, drives the bicycle forward.

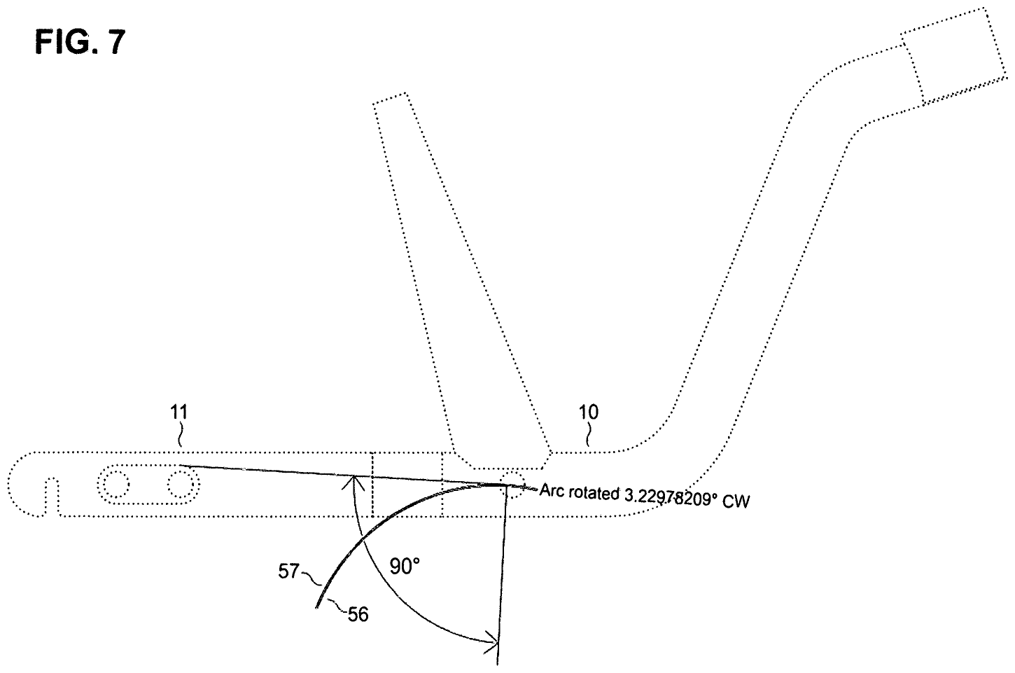

FIG. 7 presents the necessary CW rotation of cam by 3.22978209° relative to crankshaft center whereby cable meets cam and gear pulley at tangent points, so that as pedal rotates, the winding of cable about the cam begins at 0″, thereafter always increasing exponentially. Omitting said rotation, the cable winding immediately after onset of pedal rotation, can decline temporarily to a negative value.

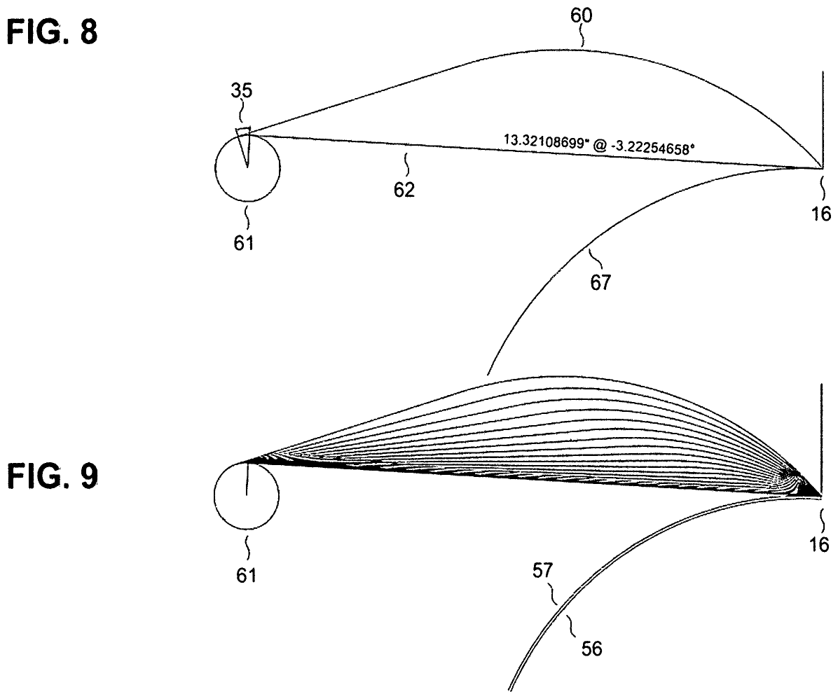

FIG. 8 is a simple line art representation of the cable 12 connected cam and gear pulley 19. Center of rotation of pedal is at 16. The geometry of the cable connection between pedal and gear pulley is based on a circle 61 of radius 0.75″ centered on center of gear pulley 61, said circle radius greater than the radius of gear pulley by a distance equal to half the diameter of the cable (0.0625″); thus establishing a starting path of the cable prior to pedal rotation; that is, at top of stroke (hereinafter, “TOS”), such that upon pedal rotation, the cam rotating with pedal, cable is deflected from its starting position at TOS and wound (essentially, pulled) increasingly onto cam, the amount 60 of cable wound onto cam substantially following the cosine function, thus increasing exponentially from zero at TOS to a length determined by degrees of pedal rotation.

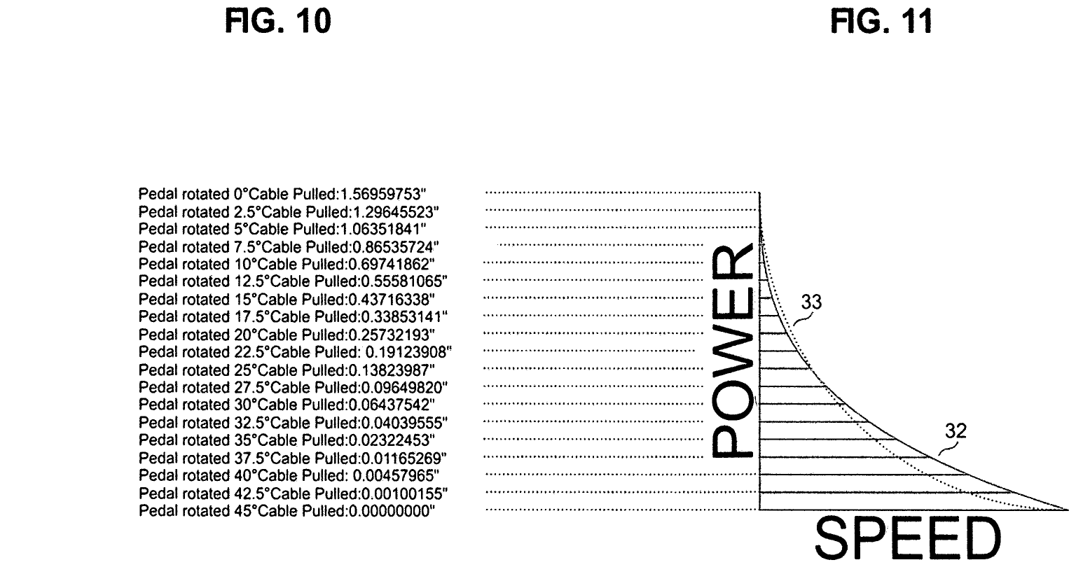

FIG. 9 shows a series of cable amounts and paths as pedal rotates in 2.5° increments from 0° to 45°. Listing these lengths as in FIG. 10 and then projecting them as horizontal lines along the X axis of an X/Y graph, followed by connecting the right ends into a curve 32 is indicative of the power/speed tradeoff as pedal rotates from TOS to BOS. For comparison, a purely circular curve 33 is juxtaposed. It is seen that the upper part of the power/speed curve 32, being relatively more vertical, somewhat favors power over speed, resulting in an increase in the force of inertial propulsion (F=mA). This is yet another element of increased power applied to the pedal in addition to those net power gains previously cited.

The maximum speed attainable, following the design geometry of the herein bicycle, and employing full pedal strokes at a pedaling cadence of 90 (three strokes in two seconds), is approximately 85 mph. The calculation of 85 mph is derived thusly: The length of cable pulled with a full down stroke equals 14.62145157″. To this must be added the length of the arc, 0.26923295″, between the tangent points on the gear pulley between TOS and BOS (arc length determined in a graphics drawing program for greater accuracy). See FIG. 8, 35. These two values sum to 14.89068452″. From this value we must subtract the cable length pre-existing prior to pedal rotation, 13.32108699″, so as to arrive at 1.56959753″ net length of cable pulled. Since this is the cable length unwound off of gear pulley and forcing it to rotate, we then divide by the circumference of gear pulley plus half the diameter of the cable=4.71238898″, thus getting a gear pulley rotation of 0.33307894 times 360°. This small rotation must then be multiplied by the overall gear ratio 36=11.99084187. This value is the number of rear wheel rotations per each complete full down stroke of 45°. Finally, to arrive at the speed, said value is multiplied by the Cadence 90 Constant 7.08627763=85 mph.

The Cadence 90 Constant is based on a 26″ diameter rear wheel, having a circumference of 81.681408993″. Given that cadence 90 is generally taken as three pedal strokes in two seconds, the value for said constant is derived thusly: It is necessary to factor in the forward (horizontal) distance of a complete down stroke, using a 5″ pedal crank with pedaling limited to 45°. This distance is 1.46446609″, which can be determined accurately by using an appropriate graphics application. Said distance is then added to the wheel circumference=83.145875083″. Multiplied by 54,000 strokes per hour divided by 63,360 inches per mile=7.08627763. This is the Cadence 90 Constant for the herein system.

Higher speeds are unlikely absent a favoring tail wind and steep downgrade. Further, air resistance increases with the cube of the velocity.

Pedal rotation is reciprocal, limited to 45° down and 45° up due to the energy savings previously discussed. Therefore, a mechanical means of limiting pedal rotation to 45° is employed consisting of a frame mounted stop bar shown in FIG. 3, 18, (also seen in FIG. 4, 18) against which hub mounted pins 17 block further rotation in either direction.

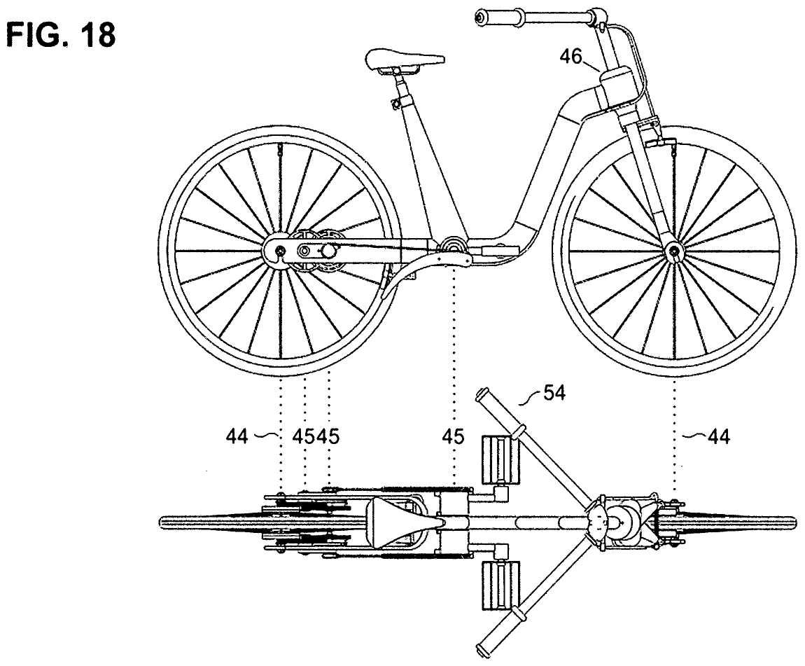

FIGS. 1 and 18 show that all drive train components, excepting frame and frame mounted stop bar, are duplicated on each side of the bicycle, such that cyclist's left foot pedals one complete system and cyclist's right foot pedals the other complete system; whereby the separation of the two above described complete systems enables independent pedaling, thus allowing cyclist to stop pedaling on one side of bicycle at any desired degree of pedal rotation, totally independent of cyclist's pedaling on the other side of the bicycle. Independent pedaling avoids the necessity of forcibly pedaling through a complete cycle, such as occurs in conventional bicycles having both pedals and cranks joined as one unit, which in some cases of heavy load, may be difficult or outright impossible. FIG. 18, 54 shows the vertical proximity of handlebar grips over the pedal, which increases the vector force with which cyclist can exert by pulling up on the handlebar grips in addition to-the force exerted on the pedals.

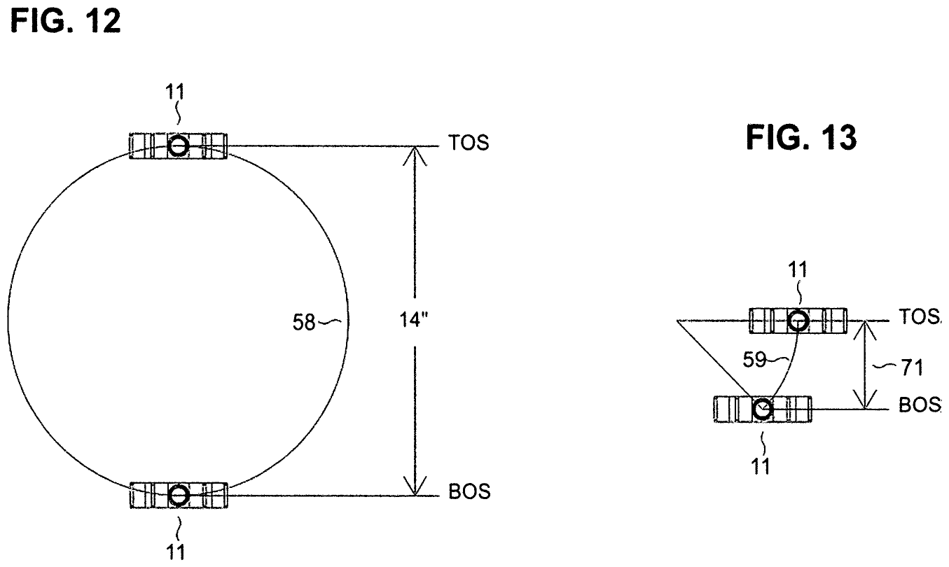

FIG. 12, 58 shows the pedal path for 360° rotary pedaling, using a 7″ pedal crank, contrasted with FIG. 13, 59. It is seen that with 360° rotary pedaling, there is a substantially greater leg and foot motion resulting in wasted energy. The vertical distance in FIG. 12 is 14″ and 3.5355″ in FIG. 13.

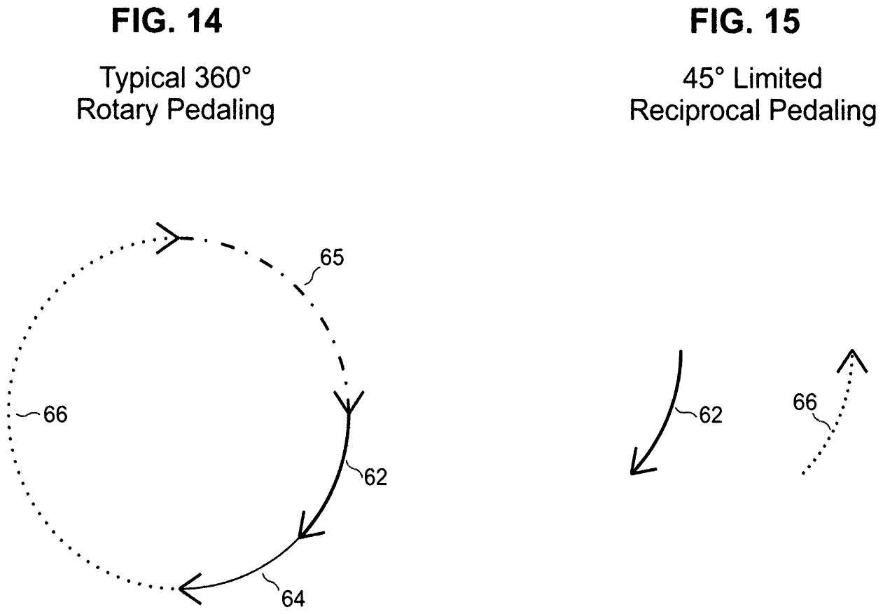

FIG. 14 is another analysis of wasted energy for 360° rotary pedaling, in which the upper right quadrant of a circle 65 is mostly wasted energy inasmuch as the cosine values in this arc sum to a negative value, the arc 62 having very efficient usage of energy, the arc 65 having partially wasted energy, again due to the cosine function, while the entire left half of the circle 66, accomplishes no useful work and is therefore a total and serious waste of energy. In contrast, FIG. 15 depicts pedal path travel as being 45° reciprocal, in case the pedal down stroke 62 is highly efficient use of energy, and the pedal upstroke 66 is a total waste of energy, unavoidable and on a much smaller scale.

FIG. 16 is a simple line art representation of a cyclist pedaling 90° using a 7″ pedal crank. Referring back to the net power gain calculations previously presented, and beneath cyclist representation, angles A, B, and C are listed, representing respectively hip, knee, and ankle rotations required to reach BOS. These rotations are associated with energy expenditure in the act of pedaling. In contrast, as seen in FIG. 17, beneath cyclist representation are angles D, E, and F. Working with these rotations in aforesaid calculations, it is found that the energy expenditure is cut in half by nearly two.

In accordance with a preferred embodiment of the invention in a high performance bicycle, there is also disclosed the following new technology:

Reduced Friction Ball Bearings. Bearing balls in external contact rotate oppositely. Lacking cages or isolators, (see below middle and right) the bearing balls cannot freely rotate about each other due to scuffing friction. The prevailing solution has been to separate the bearing balls by using cages (or isolators) which keep the balls apart and equally spaced. Scuffing or rubbing friction is thus substantially reduced. Yet, the balls rub against the cage, and measurable friction does occur. A typical coefficient of friction (steel on steel, non-lubricated) is 0.0015 to 0.0020. This results in increased starting torque.

By substituting bearing balls for cages, scuffing or rubbing is eliminated, there remaining only rolling friction, similar to steel train wheels running on steel tracks, such that the coefficient of friction is less by a factor of at least 35.

Using three polar arrays of bearing balls, the middle of which replaces cages, all balls roll on each other in the correct directions without need of friction inducing bearing cages or separators. The only friction remaining is rolling friction, for which typical coefficients vary between 0.0005 and 0.005 m, a factor of approximately 35 better and so slight as to be negligible. The geometry of the reduced friction ball bearing design is not immediately apparent, and a better grasp of the concepts may be had in approaching the design with a step-by-step 3D drawing program, such as AutoCAD, presently maintained by herein inventor and available to design engineers.

Geometrical disposition and dimensions of the reduced friction ball bearing comprises three polar arrays of bearing balls (hereinafter “balls”), each disposed concentrically about a shaft and each having a different radius as measured from center of bearing shaft, wherein the polar array having the smallest radius is designated “inner array” the polar array having the greatest radius is designated “outer array”, the polar array intermediate in radius between inner and outer arrays is designated “middle array”; configured such that

a) Middle array replaces the typical cage found in prior art ball bearings,
b) Inner array is in direct with bearing shaft,
c) Inner array is also in direct ball-to-ball contact with middle array,
d) Middle array is in direct ball-to-ball contact with outer array; however, outer array is not in contact with inner array except indirectly through intervening middle array;
e) Middle array does not contact the shaft,
f) All balls in all arrays roll directly on adjacent balls in contrary motion, thus preventing frictional contact and thereby eliminating the need for cages,
g) Inner, middle, and outer arrays consisting of 6 balls each; though the number of balls may vary to suit an intended application,
h) Inner, middle, and outer arrays are disposed axially along a shaft such that the axial distance between outer array and adjacent inner array is 0.11731905″, and the axial distance between inner array and middle array is 0.08027122″, as viewed with bearing shaft center line perpendicular to the arrays,
i) Said distances are referenced to a shaft radius of 0.25″ and a ball radius of 0.1″,
j) Inner and outer arrays are disposed radially around bearing shaft, such that the angular spacing (divergence or angular separation) is 25.70622177°, as viewed with center line of bearing shaft falling on the Z axis, and the arrays disposed on the X/Y plane,
k) Inner and middle arrays are disposed radially around bearing shaft, such that the angular spacing is 30°, as viewed with center line of bearing shaft falling on the Z axis, and the arrays disposed on the X/Y plane,
l) Middle and outer arrays ae disposed radially around bearing shaft, such that the angular spacing is 4.29377823°, as viewed with center line of bearing shaft falling on the Z axis, and the arrays disposed on the X/Y plane,
m) All balls in a given array, referenced to bearing shaft center, are radially separated by 60° from each other, as viewed with center line of bearing shaft falling on the Z axis, and arrays disposed on the X/Y plane,
n) Balls in middle array rotated three dimensionally −56° along lines through the centers of adjacent balls in inner array,
o) Each ball in outer array is rotated three dimensionally 83° around a center-to-center line between a ball in middle array and an adjacent ball in inner array,
p) Balls in the outer and middle arrays run in, respectively, an outer race and a middle race,
q) Balls in the inner array have no race, but rather, roll around in direct contact with bearing shaft,
r) The reduced friction ball bearing also comprises an outer race and a middle race wherein the inner diameter of the outer race is grooved within which groove the balls of the outer array run, thereby preventing the outer array from axial displacement along bearing shaft, said groove duplicated at an axial distance equal to the axial distance between inner and outer arrays, thereby preventing collision of inner array with outer race,
s) The end of the outer race nearest the groove nearest to the end of the outer race is permanently affixed, typically by welding, to a cylindrical bearing seal having a radius slightly greater than bearing shaft radius, 0.036 inches in height, and disposed such that it surrounds bearing shaft, the end of which lies flush with the nearest end of outer race,
t) The middle race has a radius slightly greater than bearing shaft radius and is permanently affixed to opposite end of outer race,
u) Inner array is locked between outer array and middle array, such that inner array cannot be displaced axially along the shaft or displaced relative to outer and middle arrays,
v) Size of complete reduced friction ball bearing assembly, excluding shaft, is one inch in diameter and 0.5 inch wide, though the size is scalable to other desired dimensions.

Turning now to the drawings, FIG. 18 shows the locations of the reduced friction ball bearings, as used in the herein preferred embodiment of the bicycle. Two ball bearings in tandem are used in the head joint at 46. Two ball bearings in tandem are used on each side of the bicycle at locations 45. Two single ball bearings are used on each side of the bicycle in the front and rear axles.

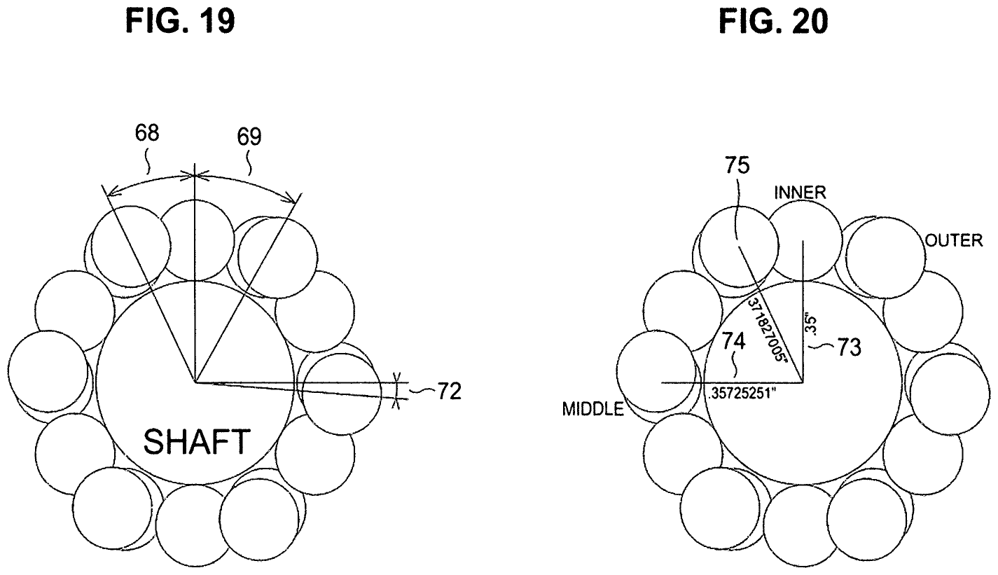

FIG. 19 shows the precise angular relationships between inner, middle, and outer arrays. Angular spacing (divergence or angular separation) between inner and outer arrays 68 is 25.70622177°, as viewed with center line of bearing shaft falling on the Z axis, and the arrays disposed on the X/Y plane. Angular spacing of inner and middle arrays 69 is 30° as viewed with center line of bearing shaft falling on the Z axis, and the arrays disposed on the X/Y plane. Angular spacing of middle and outer arrays 72 is 4.29377823°, as viewed with center line of bearing shaft falling on the Z axis, and the arrays disposed on the X/Y plane.

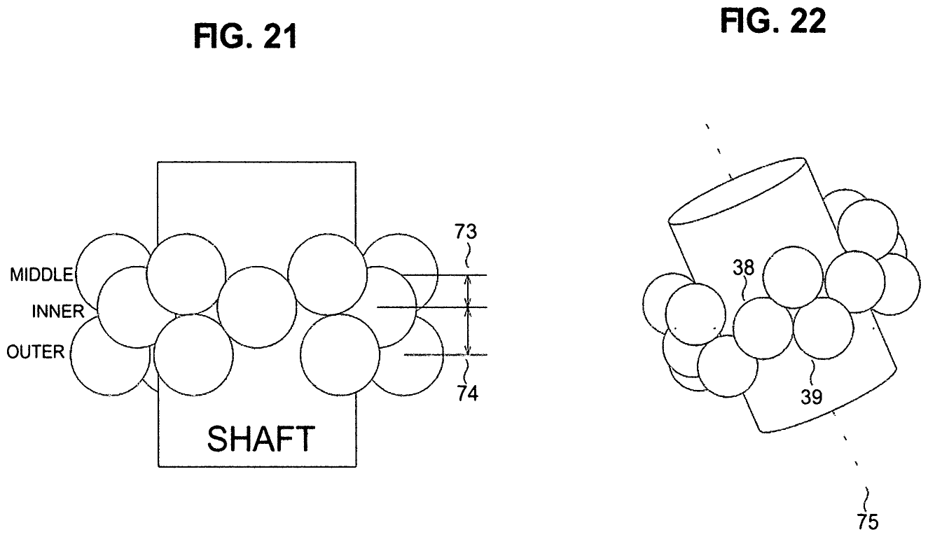

FIG. 20 shows the radius length 73 for the inner array as 0.35″, the radius length 74 of the middle array as 0.35725251″, and the radius length 75 for the outer array as 0.371827005″.

FIG. 21 shows the axial distance 74 between outer array and adjacent inner array as 0.11731905″, and the axial distance 73 between inner array and middle array as 0.08027122″, as viewed with shaft center line perpendicular to the arrays, said distances referenced to a shaft radius of 0.25″ and a ball radius of 0.1″.

FIG. 22 shows the direct ball-to-ball contact between one ball 38 of the middle array and an adjacent ball 39 of the inner array.

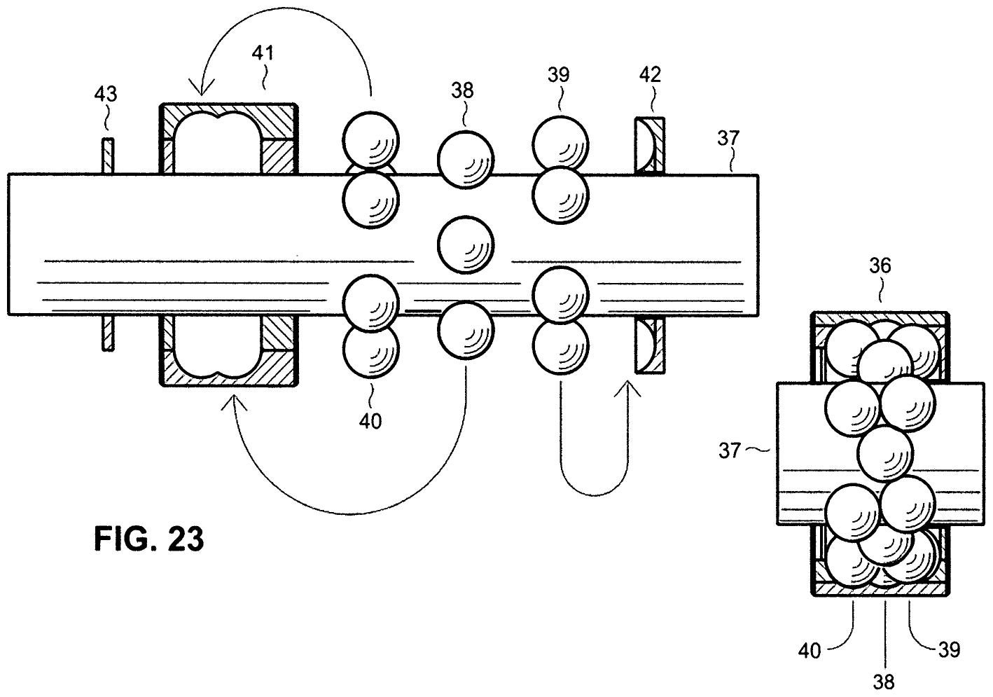

FIG. 23 is an exploded view of the reduced friction ball bearing with the shaft 37, bearing seal 43, double grooved outer race 41, outer array 40, inner array 38, middle array 39, middle array race 42. It is to be noted the outer race groove nearest the center of outer race is simply clearance for the inner array, since the inner array contacts only the shaft and middle array, and does not contact the outer race. Also shown is a non-exploded view of the ball bearing.

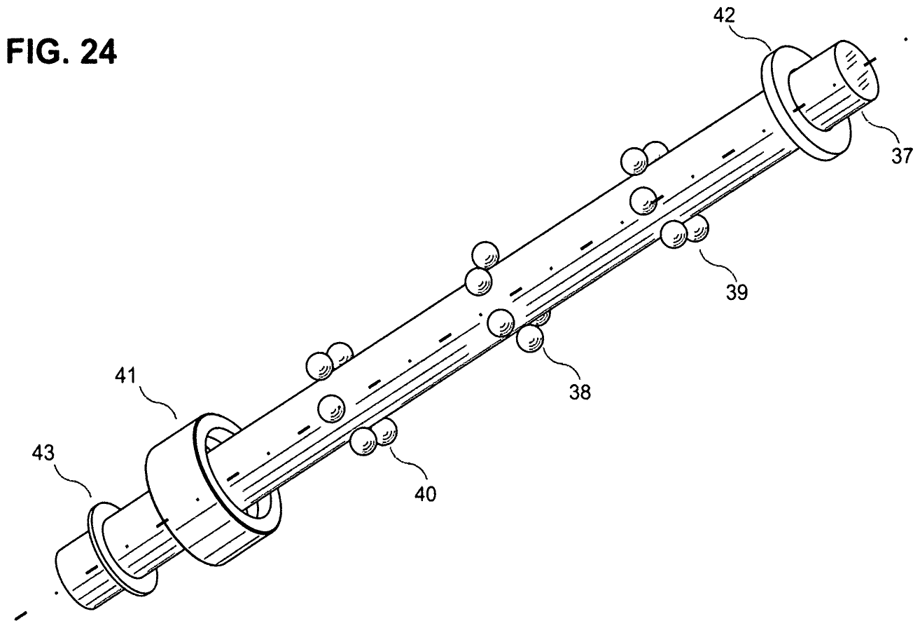

FIG. 24 is an exploded isometric view of the ball bearing, showing bearing seal 43, outer race 41, outer array 40, inner array 38, middle array 39, middle array race 42, and shaft 37.

I claim as my invention:

1. A means for converting rotary linear motion into rotary exponential motion comprising:
a bicycle frame;
a pedal, pedal crank, and hub (hereinafter, “pedal”) concentrically disposed about a crank shaft affixed to the bicycle frame;
an arc shaped cam (hereinafter, “cam”) removably attached to pedal and eccentrically disposed such that the upper quadrant of cam is below the center of rotation of pedal hub by a vertical distance equal to half the diameter of a cable or other power transmitting medium (hereinafter, “cable”);
said cable;
a gear pulley affixed to a plurality of gears;
one end of the cable affixed to the cam, the opposite end of the cable affixed to the gear pulley and partially wound about it.
geometry of the cable connection between pedal and gear pulley is based on a circle centered on center of gear pulley, said circle radius greater than the radius of gear pulley by a distance equal to half the diameter of cable; thus establishing a starting path of cable prior to pedal rotation; that is, at top of stroke (hereinafter, “TOS”); such that upon pedal rotation, cam rotating with pedal, cable is deflected from its starting position at TOS and wound (essentially, pulled) onto the cam;
amount of cable wound onto the cam substantially following the cosine function, thus increasing exponentially from zero at TOS to a length determined by degrees of pedal rotation.

2. Said plurality of gears claimed in claim 1 multiplying degrees of pedal rotation by a factor designed to meet the performance goals of the herein preferred embodiment of a bicycle, thus propelling the bicycle forward at speeds determined by degrees of pedal rotation.

3. Pedal rotation is reciprocal, limited to 45° down and 45°, as dictated not only by the fact that greater cosine averages (i.e., power efficiency) are found in the first 45° of pedaling as compared to cosine averages (power efficiency) when pedaling through 90°, but also cosine values associated with 45° pedal rotation and sine values associated with hip, knee, and ankle rotation.

4. All components described and claimed in claims 1, 2, 3, and 4 above are duplicated on each side of the bicycle, such that cyclist's left foot pedals one complete system and cyclist's right foot pedals the other complete system; whereby separation of the two above described complete systems enables independent pedaling, thus allowing cyclist to stop pedaling on one side of bicycle at any desired degree of pedal rotation, totally independent of cyclist's pedaling on the other side of the bicycle;
said independent pedaling avoiding the necessity of forcibly pedaling through a complete cycle, such as occurs in conventional bicycles having both pedals and cranks joined as one unit, which in some cases of heavy load, may be difficult or outright impossible.
I further claim as my invention

5. A reduced friction ball bearing comprising:
three polar arrays of bearing balls (hereinafter “balls”), each disposed concentrically about a bearing shaft and each having a different radius as measured from center of bearing shaft; wherein the polar array having the smallest radius is designated “inner array”, the polar array having the greatest radius is designated “outer array”, and the polar array intermediate in radius between said inner and outer arrays is designated “middle array”;
middle array replacing the typical cage found in prior art ball bearings;
inner array is in direct with bearing shaft; and also in direct ball-to-ball contact with middle array, which is in direct ball-to-ball contact with outer array;
however, the outer array is not in contact with inner array except indirectly through intervening middle array;
middle array does not contact the shaft;
all balls in all arrays roll directly on adjacent balls in contrary motion, thus preventing frictional contact and thereby eliminating the need for cages;
inner, middle, and outer arrays consisting of 6 balls each; though number of balls may vary to suit an intended application;
inner, middle, and outer arrays are disposed axially along bearing shaft such that, beginning with outer array, the axial distance between outer array and adjacent inner array is 0.11731905″, and the axial distance between inner array and middle array is 0.08027122″, as viewed with shaft center line perpendicular to the arrays, said distances referenced to a shaft radius of 0.25″ and a ball radius of 0.1″;
inner and outer arrays disposed radially around bearing shaft, such that the angular separation is 25.70622177°, as viewed with center line of bearing shaft falling on the Z axis, and the arrays disposed on the X/Y plane;
inner and middle arrays disposed radially around bearing shaft, such that the angular separation is 30°, as viewed with center line of bearing shaft falling on the Z axis, and the arrays disposed on the X/Y plane;
middle and outer arrays disposed radially around bearing shaft, such that the angular separation is 4.29377823°, as viewed with center line of bearing shaft falling on the Z axis, and the arrays disposed on the X/Y plane;
all balls in a given array, referenced to bearing shaft center, are angularly separated by 60° from each other, as viewed with center line of shaft falling on the Z axis, and the arrays disposed on the X/Y plane;
balls in middle array are rotated three dimensionally −56° along lines through the centers of adjacent balls in the inner array, and each ball in outer array is rotated three dimensionally 83° around a center-to-center line between a ball in the middle array and an adjacent ball in the inner array;
balls in outer and middle arrays running in, respectively, an outer race and a middle race;
balls in inner array have no race, but rather, roll around in direct contact with bearing shaft.

6. Reduced friction ball bearing in claim 1 comprised also of an outer race and a middle race wherein the inner diameter of the outer race is grooved within which groove the balls of the outer array run, thereby preventing outer array from axial displacement along bearing shaft, said groove duplicated at an axial distance equal to the axial distance between inner and outer arrays, thereby preventing collision of inner array with outer race;
the end of the outer race nearest the groove nearest to the end of the outer race is permanently affixed to a cylindrical bearing seal having a radius slightly greater than bearing shaft radius, 0.036 inches in height, and disposed such that it surrounds bearing shaft, the end of which lies flush with the nearest end of outer race;
middle race having a radius slightly greater than bearing shaft radius and permanently affixed to opposite end of outer race;
inner array is locked between outer array and middle array, such that inner array cannot be displaced axially along the shaft or displaced relative to outer and middle arrays.

7. Size of complete reduced friction ball bearing assembly, excluding bearing shaft, is one inch in diameter and 0.5 inch wide, though the size is scalable to other desired dimensions.
